(19) United States
(12) Patent Application Publication
(10) Pub. No.: US 2003/0020219 A1
(43) Pub. Date: Jan. 30, 2003

(54) Impact damper

(75) Inventor: Herbert Konenberg, Bruhl (DE)

Correspondence Address: COHEN, PONTANI, LIEBERMAN & PAVANE, 551 Fifth Avenue, Suite 1210, New York, NY, 10176, US

(73) Assignee: ZF Boge GmbH

(21) Appl. No.: 10/202,268

(22) Filed: Jul. 24, 2002

(30) Foreign Application Priority Data
Jul. 25, 2001 (DE) 101 36 299.4-21

(51) Int. Cl. F16F 7/12; B60R 19/34; F16M 7/00

(52) U.S. Cl. 267/139; 188/371; 293/133

(57) ABSTRACT

An impact damper as a connecting member between a bumper and a chassis of a motor vehicle for the purpose of damping the shock loading during a collision between this motor vehicle and an obstacle, comprising an inner tube which can be displaced telescopically inside an outer tube, thereby changing the volume of pressurized gas spaces. The first gas space and the second gas space have a common pressure, which is dimensioned such that optimum damping is provided for a collision between the motor vehicle and a pedestrian. It is being possible for a deformation element to be displaced as well to absorb high forces through deformation work.

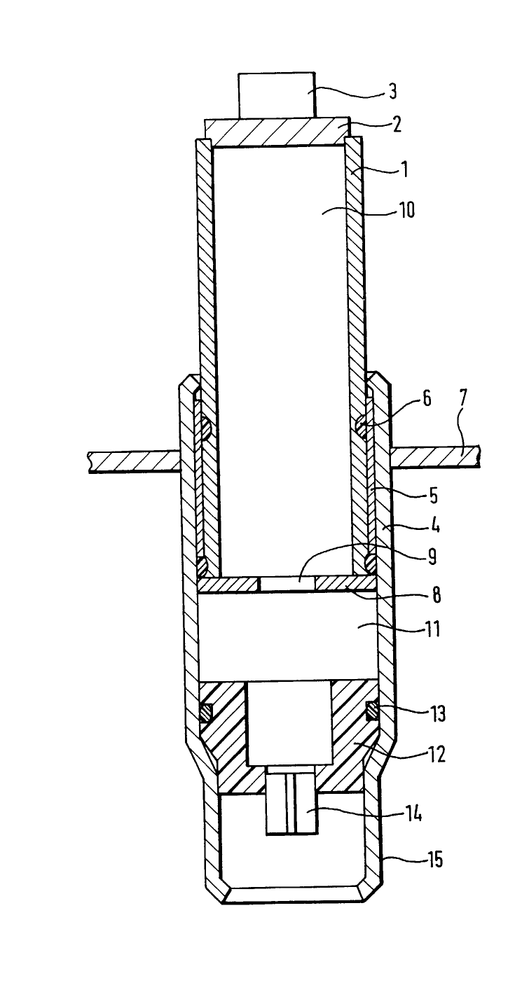

### BACKGROUND OF THE INVENTION

1. Field of the Invention

The invention relates to an impact damper as a connecting member between a bumper and a chassis of a motor vehicle for the purpose of damping the shock loading during a collision between this motor vehicle and an obstacle, comprising an inner tube, which can be displaced telescopically inside an outer tube, thereby changing the volume of pressurized gas spaces. It is possible for a deformation element to be displaced as well to absorb high impact forces through deformation work.

2. Description of the Related Art

Impact dampers of this kind are known as low-cost embodiments since they do not have a hydraulic component that, as regards the damping action, could oppose a shock load with a relatively high resistance with a relatively steep progression. It is predominantly the mass of the motor vehicle itself that impact dampers of this kind cushion when it hits an obstacle. The primary concern here is self-preservation, not the protection of the obstacle, which comprises not only parking automobiles, walls or trees but can also be a matter of two-wheeled vehicles or pedestrians. The gas spaces of conventional impact dampers are therefore preloaded with very high pressures in order to prevent permanent damage to the bumper and the chassis of the motor vehicle in the case of collision speeds of up to about 8 km/h. The inner tube is therefore pushed back into its initial position with the bumper by the gas pressure. However, as soon as this limiting speed is exceeded, permanent deformation of the impact damper occurs due to the fact that a deformation element is pushed into a constriction of the outer tube. During this process, a large amount of impact energy is absorbed, thereby ensuring that the chassis is still protected as long as the collision speed does not exceed a second, higher limiting speed of, for example, 15 km/h. Admittedly, the impact dampers and possibly also the bumpers must then be replaced.

### SUMMARY OF THE INVENTION

The impact damper according to the present invention corresponds only partially to the specifications of the above-mentioned prior art since the gas spaces of the impact damper are preloaded with lower pressures than in the prior art, thereby allowing for obstacles of relatively low mass, specifically riders of two-wheeled vehicles or pedestrians. This setting is at the expense of the possible limiting speed of the motor vehicle at which damage to the chassis begins. It is for the designer to configure the interaction between the deformation element and the smaller diameter of the outer tube in such a way as to re-establish the previously planned limiting speed for damage to the chassis of the motor vehicle by means of dimensioning. Thus, what is lacking in terms of damping force owing to the reversible damping through the gas spaces can be made up for by the second stage, that of tube deformation, by an increased deformation travel for example.

According to the invention, an impact damper is provided with gas spaces that respond even if the motor vehicle collides with light obstacles such as two-wheeled vehicles or pedestrians in order to leave less damage to these obstacles in the event of a collision.

The impact damper essentially includes an inner tube and an outer tube, within which are arranged a first and a second gas space, which are separated from one another by a dividing piston, this dividing piston having a restriction orifice. The first gas space is formed by the inner tube, which, at the bumper end, has a wall and a fastening element for fixing the bumper. At the opposite end from the wall, the dividing piston is connected to the end of the inner tube and thus closes off the first gas space. The second gas space directly adjoins the dividing piston but is already within the outer tube and, at the opposite end from the dividing piston, is bounded by the deformation element, which is likewise arranged in the outer tube and seals off the second gas space by means of sealing rings. While the bumper is connected to the inner tube at the free end of the latter, the impact damper is connected by its outer tube to the chassis by means of a mounting flange, the impact damper thereby simultaneously acting as a part for fixing the bumper on the chassis of the motor vehicle.

At the chassis end, the outer tube has a drawn-in portion, which makes the diameter of the outer tube open into a smaller diameter, into which the deformation element can be pressed when the inner tube pushes the dividing piston against the deformation element and moves the latter along further by expanding and deforming the smaller diameter of the outer tube.

If, for example, the motor vehicle collides with a pedestrian, the inner tube is pushed into the outer tube, and the pressure, which was normally identical in the first and second gas space, rises in the second gas space since the gas must flow back into the first gas space through the restriction orifice and, in the process, performs damping work, a progressive force characteristic over the sliding travel of the inner tube in the outer tube thereby being achieved, protecting the pedestrian. Depending on the speed of the motor vehicle, the entire travel between the dividing piston and the deformation element can be used up, this serving primarily to protect the pedestrian but also, on the other hand, guaranteeing that the inner tube will return to its original starting position. Only if deformations have been formed in the outer tube by the deformation element does the impact damper have to be replaced since the inner tube with its fastening element for the bumper can no longer run back into its original position.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The sole FIGURE is a longitudinal section of an impact damper according to the invention.

### DETAILED DESCRIPTION OF THE PRESENTLY PREFERRED EMBODIMENTS

The FIGURE shows a variable-length impact damper for a motor-vehicle chassis in longitudinal section, an inner tube 1, closed off from the outside by a wall 2, enclosing a first gas space 3, which is provided with a gas charge under pressure. Connected to the wall 2 is a fastening element 3, which connects the impact damper to a bumper. The inner tube 1 is mounted in a sliding manner in a sleeve 5 in an outer tube 4 and is sealed off with respect to atmosphere by a sealing ring 6. Attached to the outer tube 4 is a mounting flange 7, by means of which the impact damper is connected to the chassis of the motor vehicle. The end of the inner tube 1 in the impact damper is connected to a dividing piston 8, which has a restriction orifice 9, via which the first gas space 10 communicates with a second gas space 11, which is enclosed by the outer tube 4 and by a deformation element 12 at the opposite end from the dividing piston 8. To seal off the gas spaces 10 and 11, which are under high pressure, the deformation element has a sealing ring 13 in order to maintain the high pressure within the impact damper over the life of the impact damper. The deformation element 12 has a connection 14, via which the gas spaces 10 and 11 are filled with the pressure prescribed for the operation of the impact damper. The deformation element 12 rests on the outer tube 4 at a point with a drawn-in portion, which reduces the chassis end of the outer tube 4 to a smaller diameter 15. Owing to the high pressure within the gas spaces 10 and 11, the deformation element 12 comes to rest against the drawn-in portion in the outer tube 4 and does not change its position, even in the event of minor collisions, unless the inner tube I is pushed with its dividing piston 8 against the deformation element 12, whereby the latter is then pushed further to the end of the outer tube 4 while deforming the smaller diameter 15 of the outer tube 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An impact damper for installation between a bumper and a chassis of a motor vehicle for damping shock loading during a collision between the motor vehicle and an obstacle, said impact damper comprising
an inner tube having a first pressurized gas space,
an outer tube having a second pressurized gas space, said inner tube being telescopically displaceable in said outer tube to change the volume of at least one of said gas spaces, said gas spaces having a common pressure which is dimensioned so that telescopic displacement occurs during a collision with a pedestrian, and
a deformation element which can be displaced to absorb impact energy by deformation work when said impact energy exceeds a threshold.

2. An impact damper as in claim 1 further comprising a dividing piston fixed to said inner tube and separating said gas spaces, said piston having a restriction orifice which permits gas to flow from said second space to said first space when said inner tube is telescopically displaced into said outer tube, thereby achieving a progressive damping characteristic for said impact damper during a collision.

3. An impact damper as in claim 1 wherein said gas pressure in said spaces is sufficient to push the inner tube out of the outer tube after a collision, provided that said impact energy does not exceed said threshold.

4. An impact damper as in claim 2 wherein said outer tube is formed with a diameter restriction into which said deformation element is pushed by said dividing piston when said impact energy exceeds said threshold.

5. An impact damper as in claim 1 further comprising a connection by which said gas spaces can be provided with compressed air.

6. An impact damper as in claim 1 wherein, during collisions with massive objects, said deformation element is displaced to absorb impact energy by deformation work at collisions speeds which are substantially less than 8 km/h.
